(19) United States
(12) Patent Application Publication
(10) Pub. No.: US 2025/0258778 A1
(43) Pub. Date: Aug. 14, 2025

(54) ORDERED STORE OPERATIONS IN A MULTIPROCESSOR SYSTEM

(71) Applicant: NVIDIA CORPORATION, Santa Clara, CA (US)

(72) Inventors: Debajit BHATTACHARYA, San Jose, CA (US); Michael Allen PARKER, San Jose, CA (US); Hemayet HOSSAIN, San Jose, CA (US); James Leroy DEMING, Madison, AL (US); Wishwesh Anil GANDHI, Sunnyvale, CA (US)

(21) Appl. No.: 18/437,146

(22) Filed: Feb. 8, 2024

(51) Int. Cl. G06F 12/109

(52) U.S. Cl. CPC G06F 12/109; G06F 2212/657

(57) ABSTRACT

Various embodiments include techniques for performing memory store operations in a computing system. A memory management unit (MMU) receives various types of store operations from a processor, including unordered store operations, weak ordered store operations, and strong ordered store operations. The MMU performs virtual address to physical address translations for the store operations and forwards the translated store operations for execution. The MMU can perform translations for and forward unordered store operations and weak ordered store operations at any time. By contrast, the MMU can delay translations for and forwarding of strong ordered store operations while any prior ordered store operations are pending. In this manner, the MMU can enforce ordering of weak ordered store operations to be translated and executed prior to a subsequent strong ordered store operation. These techniques allow the processor to continue to perform other operations while ordered store operations are pending in the MMU.

### BACKGROUND

### Field of the Various Embodiments

Various embodiments relate generally to computer system architectures and, more specifically, to ordered store operations in a multiprocessor system.

### Description of the Related Art

A computing system generally includes, among other things, one or more processing units, such as central processing units (CPUs) and/or graphics processing units (GPUs), one or more memory systems, and one or more networks. Processing units execute user mode software applications, which submit and launch compute tasks, executing on one or more compute engines included in the processing units. In operation, processing units load data from the one or more memory systems, perform various arithmetic and logical operations on the data, and store data back to the one or more memory systems. One of the ways the processing units can communicate with the memory systems is via a network interface card (NIC). The NIC provides an interface between the processing units and the memory systems over various network interface protocols, including Ethernet, Peripheral Component Interconnect Express (PCIe), and/or the like.

Modern GPUs communicate with NICs frequently for the purpose of sharing data, synchronizing phases of computation, initiating new work for the GPU, the NIC, or other devices in the system, and/or the like. Consequently, compute workloads in a computing system with many GPUs, CPUs, NICs, and/or other devices can benefit when the GPUs efficiently communicate with the NIC. Additionally or alternatively, GPUs can communicate with the NIC by invoking an API call to a communication library. In response to the API call, functions included in the communication library execute to perform the communication task specified by the API call.

Given the parallel architecture of the GPU and CPU, the memory model of the computing system does not provide any guarantees for ordering between writes to different addresses from the same thread or different threads. In many cases, the CPU and/or GPU can be a relaxed memory model processing unit, where thread instructions can execute out of order. Consequently, when a first thread executes, for example, ten sequential memory operations, the tenth memory operation can complete while one or more of the first nine memory operations is still outstanding. Therefore, when there is a need for the previous memory operations to complete and/or be made visible in memory, a memory synchronization operation such as a memory barrier, a memory fence, and/or the like, is performed by the thread. The work-submission process to the NIC or the GPU internal work-creation can consist of multiple memory synchronization operations. Further, these multiple memory synchronization operations are serialized with respect to one another in order to guarantee the visibility of the prior memory operations corresponding to one memory synchronization operation before executing a subsequent memory synchronization operation.

One problem with this technique for transferring data between threads is that memory synchronization operations can take a significant amount of time to complete. Performing two to three memory synchronization operations, as described above, can consume thousands to tens of thousands of processor clock cycles, corresponding to a delay of multiple microseconds. Further, the thread that issues the memory synchronization operations can be blocked from performing further work until the memory synchronization operations complete. As a result, these memory synchronization operations can significantly reduce processor performance.

As the foregoing illustrates, what is needed in the art are more effective techniques for performing store operations in a computing system.

### SUMMARY

Various embodiments of the present disclosure set forth a computer-implemented method for performing store operations in a computing system. The method includes receiving a first store operation from a first processor. The method further includes determining that the first store operation comprises an ordered store operation of a first type. The method further includes delaying execution of the first store operation, if needed, pending receiving an acknowledgement that data for a second store operation received from the first processor comprising an ordered store operation of a second type is visible in memory. In some examples, the method can elect to not delay PCIe inbound ordered stores. With the method, the first processor continues to execute operations while the first store operation is pending.

Other embodiments include, without limitation, a system that implements one or more aspects of the disclosed techniques, and one or more computer readable media including instructions for performing one or more aspects of the disclosed techniques, as well as a method for performing one or more aspects of the disclosed techniques.

At least one technical advantage of the disclosed techniques relative to the prior art is that, with the disclosed techniques using ordered store operations, a thread can eliminate memory synchronization operations and still maintain the desired ordering between the individual store operations relative to any physical global memory aperture, such as a system (e.g., CPU attached) memory aperture, a peer device memory aperture, a local device memory aperture, and/or the like. The memory system maintains the appropriate ordering in an efficient manner, while the MMU only inserts waiting periods for visibility of the ordered store operations as needed. By so doing, a strong ordered store operation can maintain cumulative ordering of prior ordered store operations at system scope with higher performance and less processing overhead than conventional techniques that employ memory synchronization operations. These advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of a computing system configured to implement one or more aspects of the various embodiments;

FIG. 2 is a block diagram of a parallel processing unit (PPU) included in the accelerator processing subsystem of FIG. 1, according to various embodiments;

FIG. 3 is a block diagram of a general processing cluster (GPC) included in the parallel processing unit (PPU) of FIG. 2, according to various embodiments;

FIG. 4 is a block diagram of the memory management unit (MMU) of FIG. 3, according to various embodiments;

FIG. 5 is a block diagram illustrating store operations executed by an SM of FIG. 3, according to various embodiments;

FIG. 6 is a sequence diagram of ordered store operations executed by an SM of FIG. 3, according to various embodiments;

FIG. 7 is a sequence diagram of ordered store operations executed by an SM of FIG. 3, according to various other embodiments; and

FIGS. 8A-8C set forth a flow diagram of method steps for processing store operations executed by an SM of FIG. 3, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

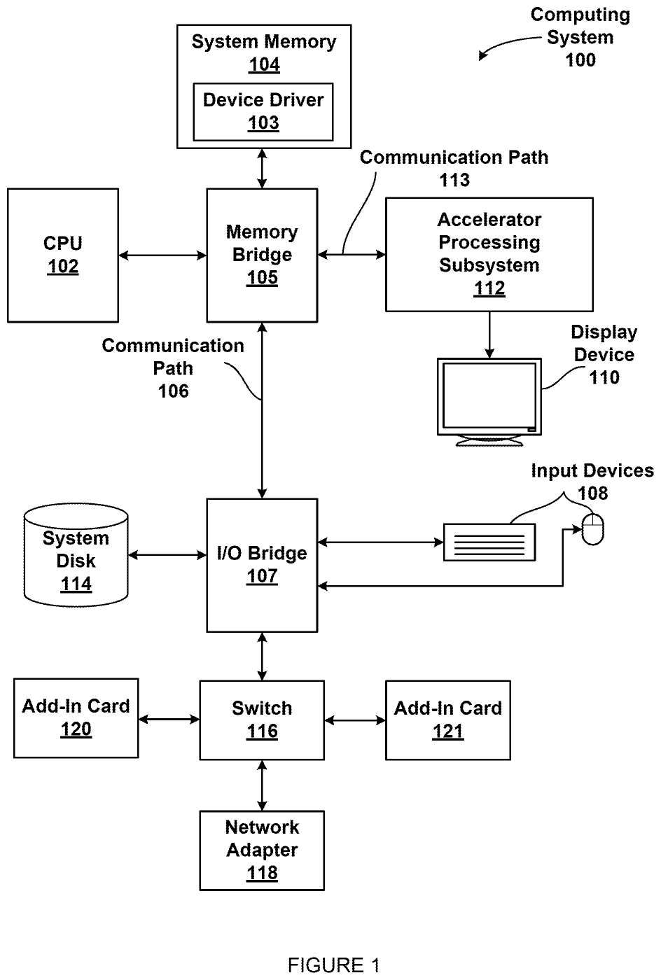

FIG. 1 is a block diagram of a computing system 100 configured to implement one or more aspects of the various embodiments. As shown, computing system 100 includes, without limitation, a central processing unit (CPU) 102 and a system memory 104 coupled to an accelerator processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In operation, I/O bridge 107 is configured to receive user input information from input devices 108, such as a keyboard or a mouse, and forward the input information to CPU 102 for processing via communication path 106 and memory bridge 105. In some examples, input devices 108 are employed to verify the identities of one or more users in order to permit access of computing system 100 to authorized users and deny access of computing system 100 to unauthorized users. Switch 116 is configured to provide connections between I/O bridge 107 and other components of the computing system 100, such as a network adapter 118 and various add-in cards 120 and 121. In some examples, network adapter 118 serves as the primary or exclusive input device to receive input data for processing via the disclosed techniques.

As also shown, I/O bridge 107 is coupled to a system disk 114 that may be configured to store content and applications and data for use by CPU 102 and accelerator processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computing system 100, may be implemented using any technically suitable protocols, including, without limitation, Peripheral Component Interconnect Express (PCIe), HyperTransport, or any other bus or point-to-point communication protocol known in the art.

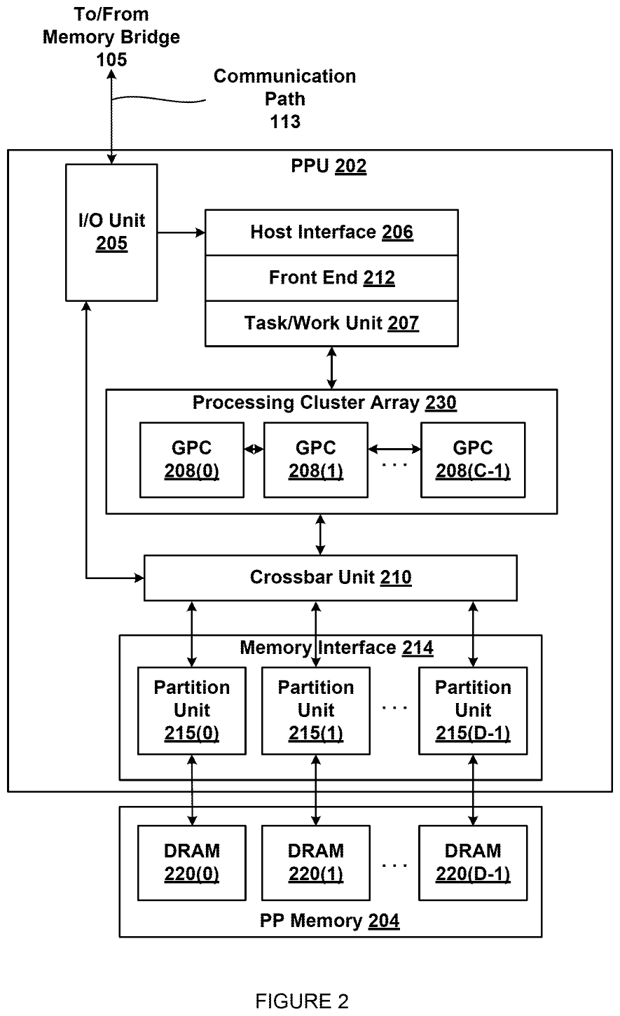

In some embodiments, accelerator processing subsystem 112 comprises a graphics subsystem that delivers pixels to a display device 110 that may be any conventional cathode ray tube, liquid crystal display, light-emitting diode display, or the like. In such embodiments, the accelerator processing subsystem 112 incorporates circuitry optimized for graphics and video processing, including, for example, video output circuitry. As described in greater detail below in FIG. 2, such circuitry may be incorporated across one or more accelerators included within accelerator processing subsystem 112. An accelerator includes any one or more processing units that can execute instructions such as a central processing unit (CPU), a parallel processing unit (PPU) of FIGS. 2-4, a graphics processing unit (GPU), a direct memory access (DMA) unit, an intelligence processing unit (IPU), neural processing unit (NAU), tensor processing unit (TPU), neural network processor (NNP), a data processing unit (DPU), a vision processing unit (VPU), an application specific integrated circuit (ASIC), a field-programmable gate array (FPGA), and/or the like.

In some embodiments, accelerator processing subsystem 112 includes two processors, referred to herein as a primary processor (normally a CPU) and a secondary processor. Typically, the primary processor is a CPU and the secondary processor is a GPU. Additionally or alternatively, each of the primary processor and the secondary processor may be any one or more of the types of accelerators disclosed herein, in any technically feasible combination. The secondary processor receives secure commands from the primary processor via a communication path that is not secured. The secondary processor accesses a memory and/or other storage system, such as such as system memory 104, Compute eXpress Link (CXL) memory expanders, memory managed disk storage, on-chip memory, and/or the like. The secondary processor accesses this memory and/or other storage system across an insecure connection. The primary processor and the secondary processor may communicate with one another via a GPU-to-GPU communications channel, such as Nvidia Link (NVLink). Further, the primary processor and the secondary processor may communicate with one another via network adapter 118. In general, the distinction between an insecure communication path and a secure communication path is application dependent. A particular application program generally considers communications within a die or package to be secure. Communications of unencrypted data over a standard communications channel, such as PCIe, are considered to be unsecure.

In some embodiments, the accelerator processing subsystem 112 incorporates circuitry optimized for general purpose and/or compute processing. Again, such circuitry may be incorporated across one or more accelerators included within accelerator processing subsystem 112 that are configured to perform such general purpose and/or compute operations. In yet other embodiments, the one or more accelerators included within accelerator processing subsystem 112 may be configured to perform graphics processing, general purpose processing, and compute processing operations. System memory 104 includes at least one device driver 103 configured to manage the processing operations of the one or more accelerators within accelerator processing subsystem 112.

In various embodiments, accelerator processing subsystem 112 may be integrated with one or more other the other elements of FIG. 1 to form a single system. For example, accelerator processing subsystem 112 may be integrated with CPU 102 and other connection circuitry on a single chip to form a system on chip (SoC).

It will be appreciated that the system shown herein is illustrative and that variations and modifications are possible. The connection topology, including the number and arrangement of bridges, the number of CPUs 102, and the number of accelerator processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, accelerator processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the accelerator processing subsystem 112 of FIG. 1, according to various embodiments. Although FIG. 2 depicts one PPU 202, as indicated above, accelerator processing subsystem 112 may include any number of PPUs 202. Further, the PPU 202 of FIG. 2 is one example of an accelerator included in accelerator processing subsystem 112 of FIG. 1. Alternative accelerators include, without limitation, CPUs, GPUs, DMA units, IPUs, NPUs, TPUs, NNPs, DPUs, VPUs, ASICs, FPGAs, and/or the like. The techniques disclosed in FIGS. 2-4 with respect to PPU 202 apply equally to any type of accelerator(s) included within accelerator processing subsystem 112, in any combination. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computing system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. Additionally or alternatively, processors and/or accelerators other than CPU 102 may write one or more streams of commands for PPU 202 to a data structure. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computing system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computing system 100 may be varied. In some embodiments, accelerator processing subsystem 112, which includes at least one PPU 202, is implemented as an add-in card that can be inserted into an expansion slot of computing system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C≥1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D≥1. Each partition unit 215 is coupled to one or more dynamic random access memories (DRAMs) 220 residing within PP memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPC 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity, and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within accelerator processing subsystem 112, or another accelerator processing subsystem 112 within computing system 100.

As noted above, any number of PPUs 202 may be included in an accelerator processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

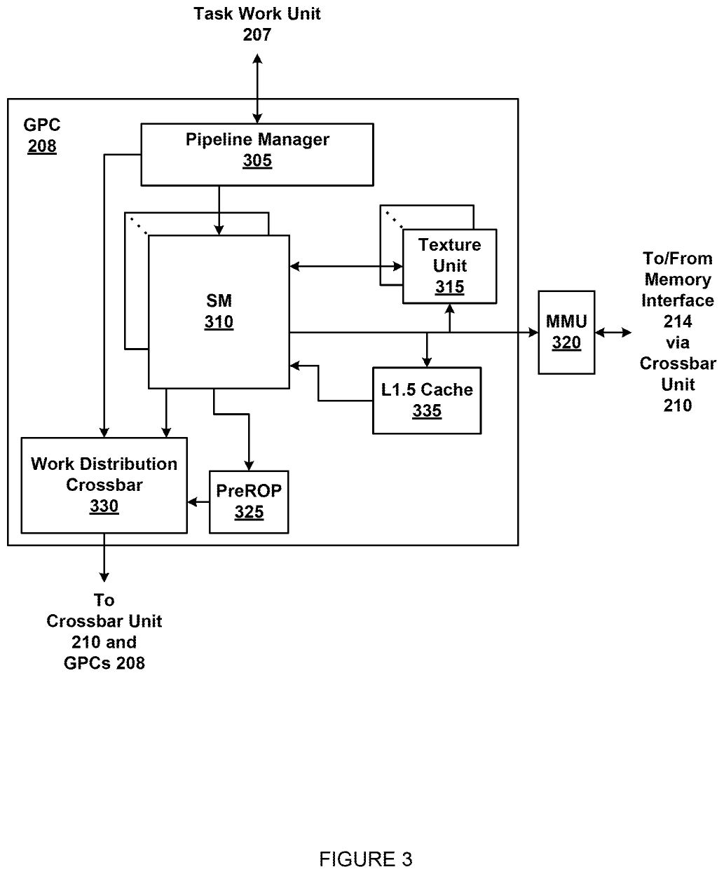

FIG. 3 is a block diagram of a general processing cluster (GPC) 208 included in the parallel processing unit (PPU) 202 of FIG. 2, according to various embodiments. In operation, GPC 208 may be configured to execute a large number of threads in parallel to perform graphics, general processing and/or compute operations. As used herein, a “thread” refers to an instance of a particular program executing on a particular set of input data. In some embodiments, single-instruction, multiple-data (SIMD) instruction issue techniques are used to support parallel execution of a large number of threads without providing multiple independent instruction units. In other embodiments, single-instruction, multiple-thread (SIMT) techniques are used to support parallel execution of a large number of generally synchronized threads, using a common instruction unit configured to issue instructions to a set of processing engines within GPC 208. Unlike a SIMD execution regime, where all processing engines typically execute identical instructions, SIMT execution allows different threads to more readily follow divergent execution paths through a given program. Persons of ordinary skill in the art will understand that a SIMD processing regime represents a functional subset of a SIMT processing regime.

Operation of GPC 208 is controlled via a pipeline manager 305 that distributes processing tasks received from a work distribution unit (not shown) within task/work unit 207 to one or more streaming multiprocessors (SMs) 310. Pipeline manager 305 may also be configured to control a work distribution crossbar 330 by specifying destinations for processed data output by SMs 310.

In one embodiment, GPC 208 includes a set of M of SMs 310, where M≥1. Also, each SM 310 includes a set of functional execution units (not shown), such as execution units and load-store units. Processing operations specific to any of the functional execution units may be pipelined, which enables a new instruction to be issued for execution before a previous instruction has completed execution. Any combination of functional execution units within a given SM 310 may be provided. In various embodiments, the functional execution units may be configured to support a variety of different operations including integer and floating point arithmetic (e.g., addition and multiplication), comparison operations, Boolean operations (e.g., AND, OR, XOR), bit-shifting, and computation of various algebraic functions (e.g., planar interpolation and trigonometric, exponential, and logarithmic functions, etc.). Advantageously, the same functional execution unit can be configured to perform different operations.

In operation, each SM 310 is configured to process one or more thread groups. As used herein, a “thread group” or “warp” refers to a group of threads concurrently executing the same program on different input data, with one thread of the group being assigned to a different execution unit within an SM 310. A thread group may include fewer threads than the number of execution units within the SM 310, in which case some of the execution may be idle during cycles when that thread group is being processed. A thread group may also include more threads than the number of execution units within the SM 310, in which case processing may occur over consecutive clock cycles. Since each SM 310 can support up to G thread groups concurrently, it follows that up to G*M thread groups can be executing in GPC 208 at any given time.

Additionally, a plurality of related thread groups may be active (in different phases of execution) at the same time within an SM 310. This collection of thread groups is referred to herein as a “cooperative thread array” (“CTA”) or “thread array.” The size of a particular CTA is equal to m*k, where k is the number of concurrently executing threads in a thread group, which is typically an integer multiple of the number of execution units within the SM 310, and m is the number of thread groups simultaneously active within the SM 310. In various embodiments, a software application written in the compute unified device architecture (CUDA) programming language describes the behavior and operation of threads executing on GPC 208, including any of the above-described behaviors and operations. A given processing task may be specified in a CUDA program such that the SM 310 may be configured to perform and/or manage general-purpose compute operations.

Although not shown in FIG. 3, each SM 310 contains a level one (L1) cache or uses space in a corresponding L1 cache outside of the SM 310 to support, among other things, load and store operations performed by the execution units. Each SM 310 also has access to level two (L2) caches (not shown) that are shared among all GPCs 208 in PPU 202. The L2 caches may be used to transfer data between threads. Finally, SMs 310 also have access to off-chip “global” memory, which may include PP memory 204 and/or system memory 104. It is to be understood that any memory external to PPU 202 may be used as global memory. Additionally, as shown in FIG. 3, a level one-point-five (L1.5) cache 335 may be included within GPC 208 and configured to receive and hold data requested from memory via memory interface 214 by SM 310. Such data may include, without limitation, instructions, uniform data, and constant data. In embodiments having multiple SMs 310 within GPC 208, the SMs 310 may beneficially share common instructions and data cached in L1.5 cache 335.

Each GPC 208 may have an associated memory management unit (MMU) 320 that is configured to map virtual addresses into physical addresses. In various embodiments, MMU 320 may reside either within GPC 208 or within the memory interface 214. The MMU 320 includes a set of page table entries (PTEs) used to map a virtual address to a physical address of a tile or memory page and optionally a cache line index. The MMU 320 may include address translation lookaside buffers (TLB) or caches that may reside within SMs 310, within one or more L1 caches, or within GPC 208.

In graphics and compute applications, GPC 208 may be configured such that each SM 310 is coupled to a texture unit 315 for performing texture mapping operations, such as determining texture sample positions, reading texture data, and filtering texture data.

In operation, each SM 310 transmits a processed task to work distribution crossbar 330 in order to provide the processed task to another GPC 208 for further processing or to store the processed task in an L2 cache (not shown), parallel processing memory 204, or system memory 104 via crossbar unit 210. In addition, a pre-raster operations (preROP) unit 325 is configured to receive data from SM 310, direct data to one or more raster operations (ROP) units within partition units 215, perform optimizations for color blending, organize pixel color data, and perform address translations.

It will be appreciated that the core architecture described herein is illustrative and that variations and modifications are possible. Among other things, any number of processing units, such as SMs 310, texture units 315, or preROP units 325, may be included within GPC 208. Further, as described above in conjunction with FIG. 2, PPU 202 may include any number of GPCs 208 that are configured to be functionally similar to one another so that execution behavior does not depend on which GPC 208 receives a particular processing task. Further, each GPC 208 operates independently of the other GPCs 208 in PPU 202 to execute tasks for one or more application programs. In view of the foregoing, persons of ordinary skill in the art will appreciate that the architecture described in FIGS. 1-3 in no way limits the scope of the various embodiments of the present disclosure.

Please note, as used herein, references to shared memory may include any one or more technically feasible memories, including, without limitation, a local memory shared by one or more SMs 310, or a memory accessible via the memory interface 214, such as a cache memory, parallel processing memory 204, or system memory 104. Please also note, as used herein, references to cache memory may include any one or more technically feasible memories, including, without limitation, an L1 cache, an L1.5 cache, and the L2 caches.

### Ordered Store Operations

Various embodiments include techniques for performing ordered store operations from a GPC client in a multiprocessor system. In some examples, the techniques perform ordered store operations from a GPC 208 to launch work to a NIC in a multiprocessor system. A NIC can operate by maintaining a circular work queue, where each entry in the queue is referred to a work queue entry (WQE). The circular work queue can be stored in any memory system, such as system memory 104, PP memory 204, and/or the like. Each WQE includes a work descriptor that informs the NIC what work is to be performed on the corresponding message data.

In some examples, one or more GPCs 208 support a GPC-direct asynchronous programming model that enables the direct data transfer of GPC-computed data from local memory of one GPC 208 (in one node) to local memory of another GPC 208 (in the same node or in another node). The direct data transfer can be performed via a device that provides network connectivity, such as a NIC, and over a communications bus, such as PCIe. The GPC-direct asynchronous data transfer enables an efficient producer-consumer programing model where a producer (such as a GPC 208) can directly ring the doorbell of a consumer (such as a NIC) without the involvement of the CPU 102.

The producer-consumer programming sequence can proceed as follows. CPU 102 generates a direct memory access (DMA) descriptor, such as a WQE, and stores the DMA descriptor in memory for the NIC to execute. CPU 102 dispatches and/or launches a compute task to GPC 208. GPC 208 executes a compute task defined by the DMA descriptor and stores the results of the compute task in a buffer in local memory. GPC 208 updates the location and/or address of the output buffer into the DMA descriptor for the NIC to access. GPC 208 issues a series of one or more register writes to the NIC over the PCIe interface, thereby indicating that the data buffer in memory is ready to be consumed. This series of one or more register writes to the NIC comprises the doorbell. In response, the NIC initiates a DMA sequence to read the buffer from GPC memory over the PCIe interface. Once CPU 102 has launched the compute task to GPC 208, this programming sequence no longer requires involvement from CPU 102. Instead, CPU 102 is free to continue working on other compute tasks or can enter an idle or gated power state.

With conventional techniques, a first thread executing on a local processor generally transmits the message data from a region of local memory to a second thread executing on a remote host via the NIC. The first thread stores the message data in memory, either by executing instructions directly or by transmitting API calls to a communication library. The first thread stores the WQE in any memory that is visible to the NIC. The first thread executes a memory synchronization operation to ensure that the message data and WQE are visible in memory. The first thread stores a doorbell record in memory, where the doorbell record includes an updated tail pointer for the circular work queue after the WQE is stored. The first thread executes a memory synchronization operation to ensure that the doorbell record is visible in memory. The first thread writes a doorbell to the NIC, indicating to the NIC that the message data, WQE, and doorbell record can be reliably accessed. The first thread executes a memory synchronization operation to ensure that the doorbell write precedes any subsequent doorbell write. The NIC and/or a second thread can now access the message data, WQE, and doorbell record. While any of the three memory synchronization operations is pending, the first thread is blocked from doing any other work.

In a specific example, after issuing a series of memory operations, the first thread stores a work queue entry (WQE) in memory, where the WQE is a work descriptor that informs the NIC what work needs to be done on the data. The first thread issues a memory synchronization operation, such as a memory barrier or a memory fence. This memory barrier ensures that the data from the ten memory operations and the associated WQE are visible in memory. The first thread generates and stores a notification record, referred to herein as a doorbell record, describing the data from the ten memory operations, such as the location of the data in memory and the total size of the data. The first thread stores the doorbell record if the NIC does not support reliable doorbells. A NIC that does not support reliable doorbells may not guarantee receipt and processing of all the doorbells in flight due to resource limitations. Therefore, the first thread stores a doorbell record as a pointer to the doorbell in memory to ensure that the NIC receives and processes each doorbell generated by the first thread. The first thread issues a second memory synchronization operation to ensure that the doorbell record is visible in memory. The first thread then generates and transmits a notification to the NIC, referred to herein as ringing a doorbell or writing a doorbell, to inform the NIC that the data and doorbell record are visible in memory. The first thread issues a third memory synchronization operation to ensure that the current doorbell write precedes a subsequent doorbell write. This third memory synchronization operation bar can be used by a special class of NICs that distinguish between even numbered doorbells and odd numbered doorbells. Upon detecting the current doorbell write, a second thread can reliably access the data via the NIC.

By contrast, with the disclosed techniques, threads executing in a computing system have an ordered view of memory. The ordered view of memory is a separate view of memory than the standard program memory view where there is no ordering between writes to different addresses without memory synchronization operations. This ordered view, from the perspective of a programmer, provides a mechanism of performing global memory store operations with embedded, hardware-enforced synchronization. The data for any store operation executed in the ordered view can be made visible to any external observer by a subsequent strong ordered store operation in the same view, without the need to execute an additional memory synchronization operation. With these techniques, the threads executing on an SM maintain ordering of store operations up to the point of issuing the store operations to the MMU 320 and memory system. The MMU 320, in turn, ensures that the store operations remain ordered with respect to the previous ordered store operations executed by the threads, as intended by the programmer. Depending on the final aperture of the translated physical address, the MMU 320 performs additional synchronization operations, as necessary, to ensure that the ordering is maintained without the aid of software techniques or instructions, such as memory synchronization operations.

The disclosed ordered store operations can be classified into two main types: weak ordered store operations and strong ordered store operations. The weak ordered store operations do not enforce strict ordering among themselves except for the basic same-thread-same-address ordering that the GPU memory model provides. Like strong ordered store operations, weak ordered store operations are part of the ordered view. In some examples, weak ordered store operations execute with higher performance than strong ordered store operations. The strong ordered store operations, on the other hand, enforce strict ordering with respect to any other prior ordered store operations (including weak ordered store operations and strong ordered store operations). The strong ordered store operations further ensure that the previous ordered store operations are visible at a relevant scope. For example, visibility at SM scope provides that data from ordered store operations is visible to threads within an SM 310. Visibility at system scope provides that data from ordered store operations is visible to all components of a computing system 100, and so on. The ordered view includes both the weak ordered store operations and strong ordered store operations. Weak ordered store operations provide better performance, although with weaker ordering assurances. Strong ordered store operations provide stricter ordering assurance with somewhat lower performance.

By using the weak ordered store operations and strong ordered store operations, the NIC communication sequence described above can be simplified as follows. A first thread executing on a local processor executes a first weak ordered store operation to store message data from a region of local memory to a second thread executing on a remote host via the NIC. The first thread stores the message data in memory, either by executing instructions directly or by transmitting API calls to a communication library. The first thread executes a second weak ordered store operation to store the WQE in any memory that is visible to the NIC. The first thread executes a first strong ordered store operation to store a doorbell record in memory, where the first strong ordered store operation ensures that the message data and WQE are visible in memory at system scope. The first thread executes a second strong ordered store operation to write a doorbell to the NIC, indicating to the NIC that the message data, WQE, and doorbell record can be reliably accessed. The second strong ordered store operation ensures that the message data, WQE, and doorbell record are visible in memory at system scope. The NIC and/or a second thread can now access the message data, WQE, and doorbell record. Because the first thread did not execute any memory synchronization operations, the first thread is not blocked from doing any other work.

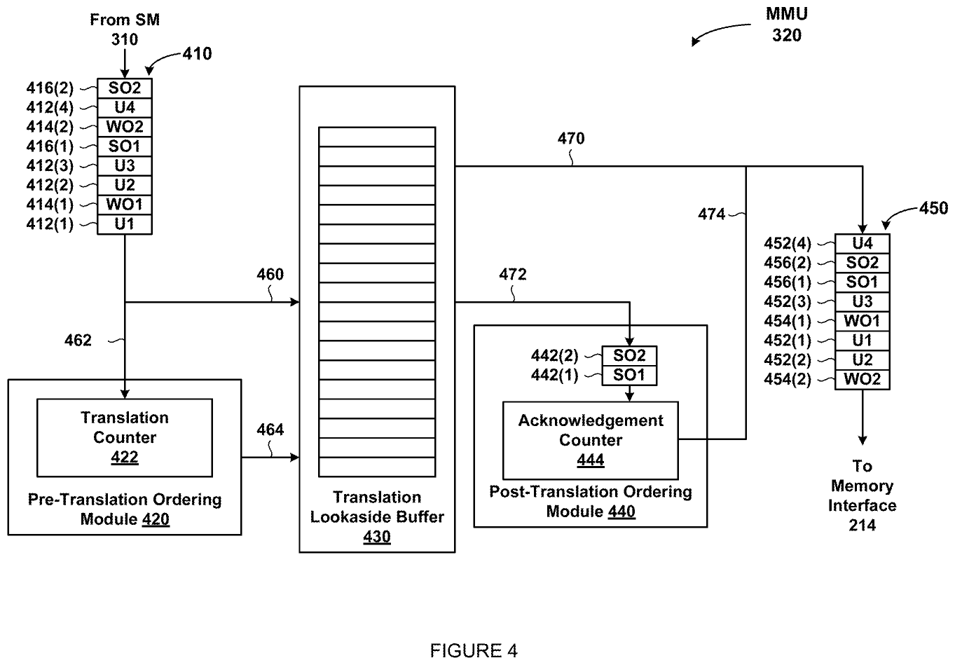

FIG. 4 is a block diagram of the memory management unit (MMU) 320 of FIG. 3, according to various embodiments. MMU 320 includes, without limitation, input store operations 410, a pre-translation ordering module 420, a translation lookaside buffer (TLB) 430, a post-translation ordering module 440, and output store operations 450.

In operation, an SM 310 transmits input store operations 410 to MMU 320. In some examples, input store operations 410 can be stored temporarily, pending address translation, in a buffer, first-in-first-out (FIFO) memory, a queue, and/or the like. Input store operations 410 include a virtual address that identifies the location where the data included in the store operation is to be stored in virtual address space. In order to store the data in physical memory, MMU 320 performs an address translation from the virtual address included in the input store operation to a corresponding physical address that identifies the location where the data included in the store operation is to be stored in physical memory. After address translation, MMU 320 generates output store operations 450 that include a physical address that identifies the location where the data included in the output store operation is to be stored in physical memory. MMU 320 transmits output store operations 450 to memory interface 214 along path 470. Additionally or alternatively, MMU 320 transmits output store operations 450 to a network interface card, a network fabric, a communications bus, and/or the like. The data included in output store operations 450 can be stored in system memory 104, in PP memory 204 of the PPU 202 that includes the SM 310 that generated the store operation, in PP memory 204 of a different PPU 202, in a memory of a different computing system 100, and/or the like.

Input store operations 410 can be unordered store operations 412, weak ordered store operations 414, or strong ordered store operations 416, or any combination thereof. As shown, input store operations 410 include four unordered store operations: U1 412(1), U2 412(2), U3 412(3), and U4 412(4). Input store operations 410 further include two weak ordered store operations: WO1 414(1) and WO2 414(2), as well as two strong ordered store operations: SO1 416(1) and SO2 416(2).

MMU 320 receives unordered store operations 412 and weak ordered store operations 414 and routes unordered store operations 412 and weak ordered store operations 414 to TLB 430 along path 460. TLB 430 includes entries that store virtual address to physical address translations for recent store operations and/or anticipated store operations. If TLB 430 includes an entry for the virtual address included in an input store operation 410, then MMU 320 generates an output store operation 450 that includes the corresponding physical address stored in the entry. MMU 320 can generate an output store operation 450 from an entry in TLB 430 with relatively low latency. If TLB 430 does not include an entry for the virtual address included in an input store operation 410, then MMU 320 can query one or more other TLBs to see if another TLB, such as a TLB for a different SM 310, includes the needed entry. If another TLB includes the needed entry, then MMU 320 can receive the entry from the other TLB and store the entry in local TLB 430. MMU 320 can generate an output store operation 450 from the entry in another TLB, but with higher latency relative to generating an output store operation 450 from an entry in local TLB 430.

If no TLB includes the needed entry, then MMU 320 can perform a page table lookup by accessing one or more page tables, where a page table includes entries that map pages of virtual memory to pages of physical memory. From data included in the entries of the one more page tables, MMU 320 generates a virtual address to physical address translation for the virtual address included in the input store operation 410. MMU 320 stores the virtual address to physical address translation as an entry in TLB 430. MMU 320 can generate an output store operation 450 from the virtual address to physical address translation determined by the page table lookup, but with higher latency relative to generating an output store operation 450 from an entry in local TLB 430 or an entry in another TLB. Consequently, because any given virtual address to physical translation may be stored in TLB 430, stored in another TLB, or generated from entries in page tables, MMU 320 can translate addresses for unordered store operations 412 and weak ordered store operations 414 in any order. After translation, MMU 320 generates output store operations 450, including unordered store operations 452 and weak ordered store operations 454, and transmits output store operations 450 to memory interface 214 along path 470. MMU 320 can store output store operations 450 in a buffer, FIFO memory, a queue, and/or the like.

To enforce ordering of address translation for certain input store operations 410, MMU 320 also receives strong ordered store operations 416. MMU 320 routes strong ordered store operations 416 to pre-translation ordering module 420 along path 462. Pre-translation ordering module 420 delays virtual address to physical address translation for the received strong ordered store operations 416 until translations for pending weak ordered store operations 414 are complete. To do so, pre-translation ordering module 420 includes a translation counter 422 that counts the number of weak ordered store operations 414 received by MMU 320 since the most recent strong ordered store operations 416 was received. Translation counter 422 increments when MMU 320 receives a weak ordered store operation 414. Translation counter 422 decrements when MMU 320 completes a virtual address to physical address translation for a weak ordered store operation 414. When translation counter 422 reaches a zero value, then all pending virtual address to physical address translations for pending weak ordered store operations 414 are complete. In response to completion of pending weak ordered store operations 414, pre-translation ordering module 420 transmits the strong ordered store operation 416 to TLB 430 along path 464. MMU 320 performs a virtual address to physical address translation for the strong ordered store operation 416, similarly to the process described herein for unordered store operations 412 and weak ordered store operations 414. After address translation, MMU 320 transmits the strong ordered store operation 416 to post-translation ordering module 440 along path 472.

In some examples, MMU 320 can receive a second strong ordered store operation 416 while a first strong ordered store operation 416 is pending in pre-translation ordering module 420. In such cases, MMU 320 holds the second strong ordered store operation 416 in input store operations 410 until pre-translation ordering module 420 completes processing of the first strong ordered store operation 416 and transmits the first strong ordered store operation 416 to TLB 430 for translation.

In some examples, MMU 320 classifies ordered store operations into different groups based on different ordering protocols employed by different destinations. Destinations for store operations are also referred to as apertures. For example, MMU 320 can classify ordered store operations into two different groups: a first group for ordered store operations that are directed to a PCIe bus aperture, referred to as PCIe-bound store operations, and a second group for ordered store operations that are directed to apertures other than a PCIe bus, referred to as non-PCIe-bound store operations.

To enforce ordering of transmission of translated non-PCIe output store operations 450, MMU 320 includes post-translation ordering module 440. Post-translation ordering module 440 receives translated strong ordered store operations 442 from TLB 430 along path 472. Post-translation ordering module 440 can store multiple translated strong ordered store operations 442 in a buffer, first-in-first-out (FIFO) memory, a queue, and/or the like. As shown, post-translation ordering module 440 holds two translated strong ordered store operations: SO1 442(1) and SO2 442(2). Post-translation ordering module 440 includes an acknowledgement counter 444 that counts the number of pending acknowledgements for certain output store operations 450, such as weak ordered store operations 454 and strong ordered store operations 456. Acknowledgement counter 444 increments when MMU 320 generates a weak ordered store operation 454 or a strong ordered store operation 456. Acknowledgement counter 444 decrements when memory interface 214 and/or other interface or communications bus acknowledges that the data for a weak ordered store operation 454 or a strong ordered store operation 456 is visible in memory at the relevant scope. When acknowledgement counter 444 reaches a zero value, then all previously sent weak ordered store operations 454 and strong ordered store operations 456 are visible in global memory. In response, post-translation ordering module 440 generates a strong ordered store operation 456 based on the corresponding translated strong ordered store operation 442. Strong ordered store operation 456 includes a physical address that identifies the location where the data included in the strong ordered store operation 456 is to be stored in physical memory. Post-translation ordering module 440 transmits the strong ordered store operation 456 as an output store operation 450 to memory interface 214 along path 474. After processing a first translated strong ordered store operation 442(1), post-translation ordering module 440 can process a second translated strong ordered store operation 442(2).

As shown, the order of output store operations 450 can be different from the order of corresponding input store operations 410. For example, weak store operations do not necessarily maintain order with one another. Therefore, although weak ordered store operation WO2 414(2) is in sixth place in input store operations 410, weak ordered store operation WO2 454(2) is in first place in output store operations 450. Weak ordered store operation WO1 414(1) is in second place in input store operations 410, but weak ordered store operation WO1 454(1) is in fourth place in output store operations 450.

Strong ordered store operations maintain order with one another. Therefore, because strong ordered store operation SO1 416(1) is before strong ordered store operation SO2 416(2) in input store operations 410, strong ordered store operation SO1 456(1) is before strong ordered store operation SO2 456(2) in output store operations 450 as well. Further, each strong ordered store operation ensures that prior weak ordered store operations are transmitted and acknowledged before the strong ordered store operation is transmitted. Therefore, because weak ordered store operation WO1 414(1) is before strong ordered store operation SO1 416(1) in input store operations 410, weak ordered store operation WO1 454(1) is before strong ordered store operation SO1 456(1) as well. Similarly, because weak ordered store operation WO2 414(2) is before strong ordered store operation SO2 416(2) in input store operations 410, weak ordered store operation WO2 454(2) is before strong ordered store operation SO2 456(2) as well.

Unordered store operations do not necessarily maintain order with one another, with weak store operations, or with strong store operations. Therefore, unordered store operation U1 412(1) is before unordered store operation U2 412(2) in input store operations 410, but unordered store operation U2 452(2) is before unordered store operation U1 452(1) in output store operations 450. Similarly, unordered store operation U2 412(2) is before weak ordered store operation WO2 414(2) in input store operations 410, but weak ordered store operation WO2 454(2) is before unordered store operation U2 452(2) in output store operations 450. Likewise, unordered store operation U4 412(4) is before strong ordered store operation SO2 416(2) in input store operations 410, but strong ordered store operation SO2 456(2) is before unordered store operation U4 452(4) in output store operations 450.

MMU 320 relies on a PCIe ordering mechanism to enforce ordering of output store operations directed to the PCIe bus. Store operations directed to the PCIe bus are posted store operations. With posted store operations, the PCIe bus does not return an acknowledgement when a store operation completes, and the data included in the store operation is visible at the destination. Further, PCIe semantics enforces that consecutive store operations to any addresses in the PCIe bus address space remain in order. Apertures other than the PCIe bus, such as PP memory 204 of the local PPU 202, PP memory 204 of a peer PPU 202, system memory 104, and/or the like, support non-posted store operations. With non-posted store operations, MMU 320 receives an acknowledgement when a store operation completes, and the data included in the store operation is visible at the destination. However, with non-posted store operations, ordering between consecutive store operations to different addresses in those apertures is not guaranteed. Consequently, in some examples, when an ordered store operation directed to an interface that supports posted store operations, such as a PCIe interface, is followed by an ordered store operation directed to an interface that does not support posted store operations, MMU 320 performs an aperture switch I/O flush operation. This aperture switch I/O flush operation ensures that data from ordered store operations directed to the interface that supports posted store operations are visible in memory before processing ordered store operations directed to any interface that supports non-posted store operations. This aperture switch I/O flush operation essentially inserts or issues a dummy read operation on the PCIe bus, which is, by definition, non-posted. According to PCIe ordering rules, non-posted operations push prior posted operations. As a result, the dummy read response from the aperture switch I/O flush operation ensures that the prior posted store operations have been made visible in memory. In response to receiving a read operation response to the dummy read operation indicating that data associated with the posted operations is visible in memory the non-posted operation is allowed to proceed.

To enforce ordering of the described ordered store operations, MMU 320 waits for acknowledgements in response to store operations directed to non-PCIe apertures and transmits store operations directed to the PCIe aperture in the original order as received. MMU 320 enforces that a strong ordered store operation directed to a non-PCIe aperture waits for acknowledgements from prior strong ordered store operations and prior weak ordered store operations. MMU 320 can store and hold, or delay, these strong ordered store operations in a buffer, FIFO memory, a queue, and/or the like included in a post-translation ordering module 440. In some examples, a strong ordered store operation to a non-PCIe aperture can also flush prior ordered store operations to the PCIe aperture. In such examples, MMU 320 executes a flush operation that flushes only the prior ordered store operations directed towards the PCIe aperture. This flush operation does not flush unordered store operations. This flush operation also does not flush ordered store operations that are directed towards non-PCIe apertures.

Because of the store operation ordering behavior of the PCIe bus, MMU 320 can transmit a stream of back-to-back strong ordered store operations to the PCIe aperture. In order to ensure that these PCIe ordered write operations reach the PCIe bus in the originally received order, MMU 320 transmits the ordered store operations included in the set of ordered store operations via the same fixed path through the memory system. This fixed path for the set of ordered store operations is determined by a special fixed path address map, referred to as the fixed-path AMAP. With the fixed-path AMAP, the input/output ports and the L2 cache memory slices in the memory system are selected based on the identifier of the TLB 430 associated with the originally requesting SM 310 and/or the identifier of the SM 310 of the originally requesting SM 310. By contrast, with the standard AMAP, the input/output ports and the L2 cache memory slices in the memory system are selected based on the address included in the store operation. Therefore, ordered store operations using the standard AMAP would not be restricted to travel on a single fixed path.

When transmitted through an L2 cache memory slice, these fixed-path store operations are marked as non-cacheable by MMU 320. MMU2 marks fixed-path store operations as non-cacheable because the fixed-path store operations are transmitted to a different L2 cache memory than would be intended with the standard AMAP. Therefore, the fixed-path store operations should not be cached in the L2 cache memory. This fixed path allows ordered store operations directed towards the PCIe aperture to be streamed to the PCIe subsystem back-to-back, leading to an efficient ordering mechanism. MMU 320 can use this PCIe ordering mechanism to communicate with a PCIe-attached network interface and/or other PCIe-attached input/output devices. MMU 320 can transmit the store operations back-to-back without stalling the SM 310 or MMU 320 while, at the same time, ensure ordering of the ordered store operations transmitted to the PCIe aperture.

In some examples, MMU 320 can process the two phases of ordering, namely pre-translation ordering and post-translation ordering, separately, as described herein. Additionally or alternatively, MMU 320 can implement a unified ordering controller that processes the two phases of ordering together. In such examples, MMU 320 does not impose pre-translation delay of execution of strong ordered store operations. Instead, MMU 320 imposes ordering of store operations in the post-translation phase. Note that MMU 320 can complete address translation for a strong ordered store operation before completing address translation for a prior weak ordered store operation. However, MMU 320 ensures that data for a weak ordered store operation is made visible at the destination before data for a subsequent strong ordered store operation is made visible at the destination.

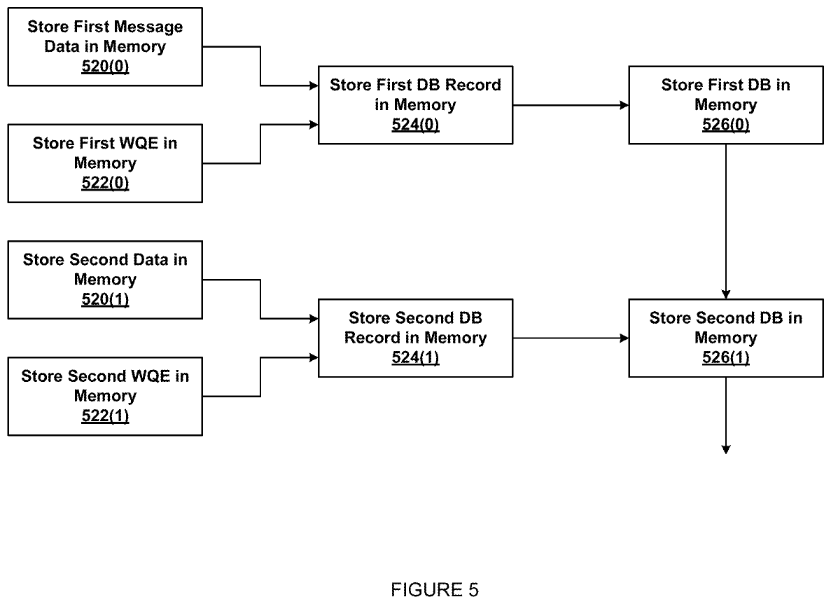

FIG. 5 is a block diagram illustrating store operations executed by an SM 310 of FIG. 3, according to various embodiments. As shown, an SM 310 stores first message data in memory 520(0) by executing a weak ordered store operation. SM 310 stores the first message data in memory, either by executing instructions directly or by transmitting API calls to a communication library. SM 310 stores a first work queue entry (WQE) in memory 522(0) by executing a weak ordered store operation. SM 310 stores the first WQE in any memory that is visible to the memory interface 214. The WQEs are stored in a circular work queue, where each entry in the queue is a work queue entry (WQE). The circular work queue can be stored in any memory system, such as system memory, PP memory, and/or the like. The first WQE includes a work descriptor that informs the memory interface 214 what work is to be performed on the first message data. Because the store operations for the first message data and the first WQE are executed as weak ordered store operations, MMU 320 can process the two weak ordered store operations in any order.

SM 310 stores a first doorbell (DB) record in memory 524(0) by executing a strong ordered store operation. The first doorbell record includes an updated tail pointer for the circular work queue after the first WQE is stored. Because the store operation for the first doorbell record is executed as a strong ordered store operation, MMU 320 holds the store operation for the first doorbell record until the first message data and the first WQE are visible in memory. Once the first doorbell record and the first WQE are visible in memory, MMU 320 can process the strong ordered store operation for the first doorbell record. SM 310 stores a first doorbell (DB) in memory 526(0) by executing a strong ordered store operation. The first doorbell indicates that the first message data, the first WQE, and the first doorbell record can be reliably accessed. Because the store operation for the first doorbell is executed as a strong ordered store operation, MMU 320 holds the store operation for the first doorbell until the first message data, the first WQE, and the first doorbell record are visible in memory. Once the first message data, the first WQE, and the first doorbell record are visible in memory, MMU 320 can process the strong ordered store operation for the first doorbell.

SM 310 stores second message data in memory 520(1) by executing a weak ordered store operation. SM 310 stores the second message data in memory, either by executing instructions directly or by transmitting API calls to a communication library. SM 310 stores a second work queue entry (WQE) in memory 522(1) by executing a weak ordered store operation. SM 310 stores the second WQE in any memory that is visible to the memory interface 214. The second WQE includes a work descriptor that informs the memory interface 214 what work is to be performed on the second message data. Because the store operations for the first message data, the first WQE, the second message data, and the second WQE are executed as weak ordered store operations, MMU 320 can process the four weak ordered store operations in any order.

SM 310 stores a second doorbell (DB) record in memory 524(1) by executing a strong ordered store operation. The second doorbell record includes an updated tail pointer for the circular work queue after the second WQE is stored. Because the store operation for the second doorbell record is executed as a strong ordered store operation, MMU 320 holds the store operation for the second doorbell record until the second message data and the second WQE are visible in memory. Once the second doorbell record and the second WQE are visible in memory, MMU 320 can process the strong ordered store operation for the second doorbell record. SM 310 stores a second doorbell (DB) in memory 526(1) by executing a strong ordered store operation. The second doorbell indicates that the second message data, the second WQE, and the second doorbell record can be reliably accessed. Because the store operation for the second doorbell is executed as a strong ordered store operation, MMU 320 holds the store operation for the second doorbell until the first doorbell, the second message data, the second WQE, and the second doorbell record are visible in memory. Once the first doorbell, the second message data, the second WQE, and the second doorbell record are visible in memory, MMU 320 can process the strong ordered store operation for the second doorbell. In this manner, MMU 320 can ensure the desired ordering of the weak ordered store operations and the strong ordered store operations without the need for SM 310 to execute any memory synchronization operations.

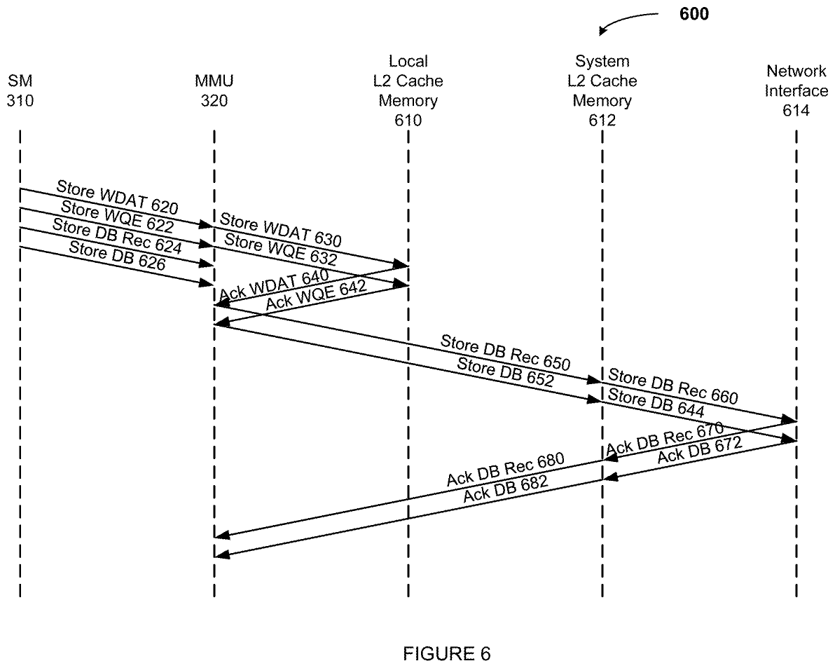

FIG. 6 is a sequence diagram of ordered store operations executed by an SM 310 of FIG. 3, according to various embodiments. As shown, an SM 310 executes four ordered store operations. A first ordered store operation stores write data (store WDAT 620). A second ordered store operation stores a work queue entry (store WQE 622) corresponding to the write data. SM 310 executes the first ordered store operation and the second ordered store operation as weak ordered store operations. A third ordered store operation stores a doorbell record (store DB rec 624). A fourth ordered store operation stores a doorbell (store DB 626) corresponding to the doorbell record. SM 310 executes the third ordered store operation and the fourth ordered store operation as strong ordered store operations.

Because the first ordered store operation and the second ordered store operation are weak ordered store operations, MMU 320 can process these two ordered store operations in any order. After address translation, MMU 320 determines that the first ordered store operation and the second ordered store operation are directed to a peer memory aperture. Therefore, MMU 320 transmits the first ordered store operation (store WDAT 630) and the second ordered store operation (store WQE 632) to local L2 cache memory 610. When MMU 320 receives the third ordered store operation, a strong ordered store operation, MMU 320 completes address translation and then waits pending receiving acknowledgements that data for the first ordered store operation (ack WDAT 640) and the second ordered store operation (ack WQE 642) are visible in memory.

Upon receiving the two acknowledgements, MMU 320 processes the third ordered store operation. MMU 320 determines that the third ordered store operation is directed to a PCIe aperture. MMU 320 determines that the fourth ordered store operation is also directed to the PCIe aperture. Therefore, MMU 320 can transmit the third ordered store operation and the fourth ordered store operation in order, and the PCIe bus can maintain the order of the third ordered store operation and the fourth ordered store operation. Therefore, MMU 320 transmits the third ordered store operation (store DB rec 650) and the fourth ordered store operation (store DB 652) to system L2 cache memory 612. In some examples, because the PCIe bus maintains ordering and because the third ordered store operation (store DB rec 650) and the fourth ordered store operation (store DB 652) are destined for the PCIe bus, MMU 320 does not need to wait for acknowledgement of the third ordered store operation before transmitting the fourth ordered store operation because both 3rd and 4th ordered store operations are destined to the PCIe bus. System L2 cache memory 612, in turn, forwards the third ordered store operation (store DB rec 660) and the fourth ordered store operation (store DB 662) to network interface 614. Network interface 614 forwards the third ordered store operation and the fourth ordered store operation to the PCIe bus. Network interface 614 generates acknowledgements that data for the third ordered store operation (ack DB rec 670) and the fourth ordered store operation (ack DB 672) have been forwarded to the PCIe bus. Network interface 614 transmits the acknowledgements for the third ordered store operation (ack DB rec 670) and the fourth ordered store operation (ack DB 672) to system L2 cache memory 612. System L2 cache memory 612, in turn, forwards the acknowledgements for the third ordered store operation (ack DB rec 680) and the fourth ordered store operation (ack DB 682) to MMU 320.

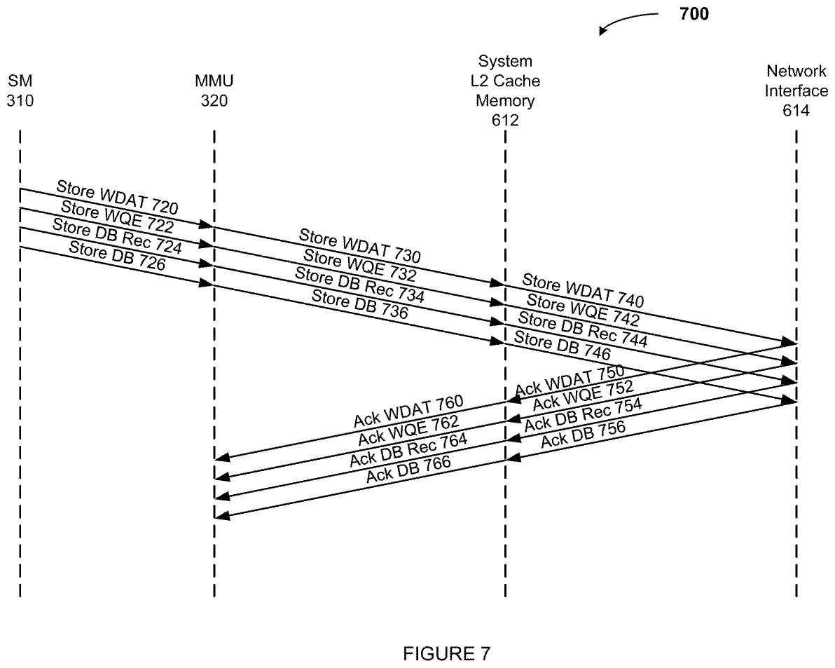

FIG. 7 is a sequence diagram of ordered store operations executed by an SM 310 of FIG. 3, according to various other embodiments. As shown, an SM 310 executes four ordered store operations. A first ordered store operation stores write data (store WDAT 720). A second ordered store operation stores a work queue entry (store WQE 722) corresponding to the write data. SM 310 executes the first ordered store operation and the second ordered store operation as weak ordered store operations. A third ordered store operation stores a doorbell record (store DB rec 724). A fourth ordered store operation stores a doorbell (store DB 726) corresponding to the doorbell record. SM 310 executes the third ordered store operation and the fourth ordered store operation as strong ordered store operations.

Because the first ordered store operation and the second ordered store operation are weak ordered store operations, MMU 320 can process these two ordered store operations in any order. After address translation, MMU 320 determines that the first ordered store operation and the second ordered store operation are directed to a PCIe aperture. After address translation, MMU 320 determines that the third ordered store operation and the fourth ordered store operation are also directed to the PCIe aperture. Therefore, MMU 320 can transmit the four ordered store operations in order, and the PCIe bus can maintain the order of the four ordered store operations.

Therefore, MMU 320 transmits the first ordered store operation (store WDAT 730), the second ordered store operation (store WQE 732), the third ordered store operation (store DB rec 734), and the fourth ordered store operation (store DB 736) to system L2 cache memory 612. System L2 cache memory 612, in turn, forwards the first ordered store operation (store WDAT 740), the second ordered store operation (store WQE 742), the third ordered store operation (store DB rec 744), and the fourth ordered store operation (store DB 746) to network interface 614. Network interface 614 forwards the four ordered store operations, in order, to the PCIe bus. Network interface 614 generates acknowledgements that data for the first ordered store operation (ack WDAT 750), the second ordered store operation (ack WQE 752), the third ordered store operation (ack DB rec 754), and the fourth ordered store operation (ack DB 756) have been forwarded to the PCIe bus. Network interface 614 transmits the acknowledgements for the first ordered store operation (ack WDAT 750), the second ordered store operation (ack WQE 752), the third ordered store operation (ack DB rec 754), and the fourth ordered store operation (ack DB 756) to system L2 cache memory 612. System L2 cache memory 612, in turn, forwards the acknowledgements for the first ordered store operation (ack WDAT 760), the second ordered store operation (ack WQE 762), the third ordered store operation (ack DB rec 764), and the fourth ordered store operation (ack DB 766) to MMU 320. In some examples, MMU 320 does not need to wait for any of these acknowledgements before transmitting the ordered store operations.

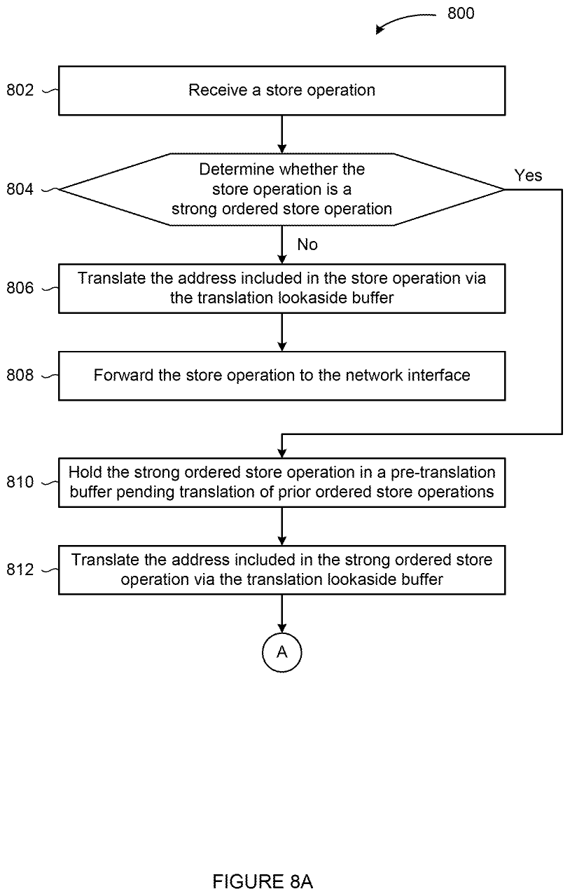

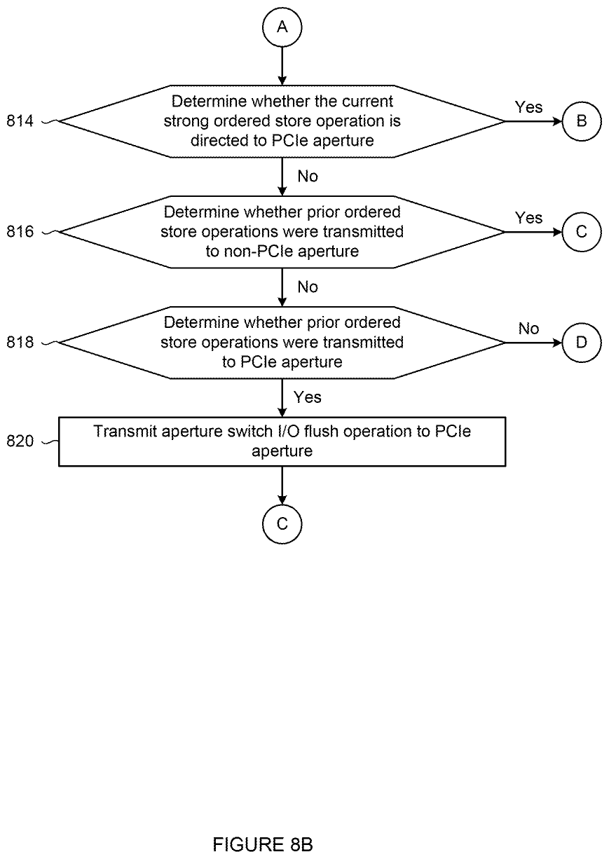

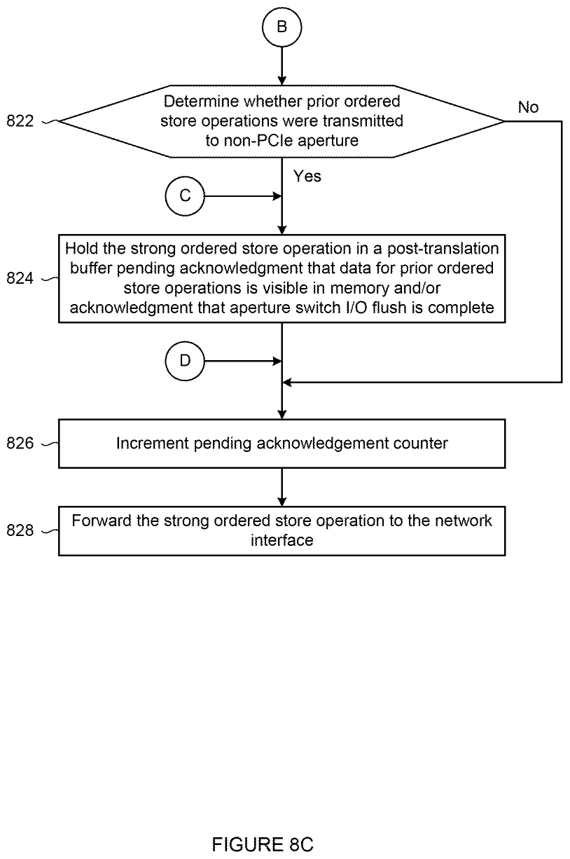

FIGS. 8A-8C set forth a flow diagram of method steps for processing store operations executed by an SM 310 of FIG. 3, according to various embodiments. Additionally or alternatively, the method steps can be performed by one or more alternative accelerators including, without limitation, CPUs, GPUs, DMA units, IPUs, NPUs, TPUs, NNPs, DPUs, VPUs, ASICs, FPGAs, and/or the like, in any combination. Although the method steps are described in conjunction with the systems of FIGS. 1-7, persons of ordinary skill in the art will understand that any system configured to perform the method steps, in any order, is within the scope of the present disclosure.

As shown, a method 800 begins at step 802, where a memory management unit, such MMU 320 included in SM 310, receives a store operation from SM 310. SM 310 executes the store operation to store data in a memory location specified by a virtual address. The store operation can be an unordered store operation, a weak ordered store operation, or a strong ordered store operation.

At step 804, the memory management unit determines whether the store operation is a strong ordered store operation. If the store operation is not a strong ordered store operation, then the store operation is either an unordered store operation or a weak ordered store operation. The memory management unit can process unordered store operations and weak ordered store operations in any order.

If the store operation is not a strong ordered store operation, then the method proceeds to step 806, where the memory management unit translates the address included in the store operation via a translation lookaside buffer. In so doing, the memory management unit translates the virtual address included in the store operation to a physical address of a location in physical memory where the corresponding data resides when the store operation completes. The memory management unit can perform the virtual address to physical address by accessing an entry in a translation lookaside buffer that is local to the memory management unit. Additionally or alternatively, the memory management unit can perform the virtual address to physical address by accessing a translation lookaside buffer that is associated with another memory management unit. In either case, the entries of the translation lookaside buffers include entries that store virtual address to physical address translations for recent store operations and/or anticipated store operations. If no translation lookaside buffer includes the needed entry, then the memory management unit can perform a page table lookup by accessing one or more page tables. The one or more page tables include entries that map pages of virtual memory to pages of physical memory. From data included in the entries of the one more page tables, the memory management unit generates a virtual address to physical address translation for the virtual address included in the store operation.

At step 808, the memory management unit forwards the store operation to the network interface. The memory management unit can forward the store operation to different destinations depending on the aperture associated by the physical address accessed by the store operation. The method 800 then terminates. Alternatively, the method 800 proceeds to step 802, described above, to process additional store operations.

Returning to step 804, if the store operation is a strong ordered store operation, then the method 800 proceeds to step 810, where the memory management unit holds the strong ordered store operation in a pre-translation buffer pending translation of prior ordered store operations. The pre-translation ordering module delays virtual address to physical address translation for the received strong ordered store operation until translations for pending weak ordered store operations are complete. To do so, the pre-translation ordering module includes a translation counter that counts the number of weak ordered store operations received by the memory management unit since the most recent strong ordered store operations was received. The translation counter increments when the memory management unit receives a weak ordered store operation or a strong ordered store operation. The translation counter decrements when the memory management unit completes a virtual address to physical address translation for a weak ordered store operation. When the translation counter reaches a zero value, then all pending virtual address to physical address translations for pending weak ordered store operations are complete.

At step 812, the memory management unit translates the address included in the strong ordered store operation via a translation lookaside buffer. In so doing, the memory management unit translates the virtual address included in the strong ordered store operation to a physical address of a location in physical memory where the corresponding data resides when the strong ordered store operation completes. The memory management unit can perform the virtual address to physical address as described in conjunction with step 806.

At step 814, the memory management unit determines whether the current strong ordered store operation is directed to the PCIe aperture. More generally, the memory management unit determines whether the strong ordered store operation is directed to an aperture that supports posted operations. In such cases, the memory management unit can utilize the ordering enforced by the aperture that supports posted operations. If the current strong ordered store operation is not directed to the PCIe aperture, then the method 800 proceeds to step 816.

At step 816, the memory management unit cannot rely on ordering enforced by the aperture. The memory management unit determines whether one or more prior ordered store operations were transmitted to a non-PCIe aperture. More generally, the memory management unit determines whether prior ordered store operations were transmitted to an aperture that does not support posted operations. If no prior ordered store operations were transmitted to a non-PCIe aperture, then the method 800 proceeds to step 818.

At step 818, the memory management unit has determined that the current strong ordered store operation is directed to a non-PCIe aperture and no prior ordered store operations were transmitted to a non-PCIe aperture. The memory management unit determines whether one or more prior ordered store operations were transmitted to a PCIe aperture. If prior ordered store operations were transmitted to a PCIe aperture, then the method 800 proceeds to step 820.

At step 820, the memory management unit has determined that the current strong ordered store operation is directed to a non-PCIe aperture, no prior ordered store operations were transmitted to a non-PCIe aperture, and at least one prior ordered store operation was transmitted to a PCIe aperture. In such cases, the system has switched from transmitting ordered operations to a PCIe interface to transmitting ordered operations to a non-PCIe interface. In such cases, the memory management unit transmits an aperture switch I/O flush operation to the PCIe interface. This aperture switch I/O flush operation ensures that data from ordered store operations directed to the interface that supports posted store operations are visible in memory before processing ordered store operations directed to any interface that does not support posted store operations. This aperture switch I/O flush operation essentially inserts or issues a dummy read operation on the PCIe bus, which is, by definition, non-posted. According to PCIe ordering rules, non-posted operations push prior posted operations. As a result, the dummy read response from the aperture switch I/O flush operation ensures that the prior posted store operations have been made visible in memory.

At step 824 the memory management unit holds the strong ordered store operation in a post-translation buffer pending acknowledgement that data for prior ordered store operations is visible in memory and/or acknowledgement that a pending aperture switch I/O flush operation is complete. The post-translation ordering module receives translated strong ordered store operations from the translation lookaside buffer. The post-translation ordering module can store multiple translated strong ordered store operations in a buffer, first-in-first-out (FIFO) memory, a queue, and/or the like. The post-translation ordering module includes an acknowledgement counter that counts the number of pending acknowledgements for weak ordered store operations and strong ordered store operations. The acknowledgement counter increments when the memory management unit generates a weak ordered store operation or a strong ordered store operation. The acknowledgement counter decrements when the network interface and/or other interface or communications bus acknowledges that the data for a weak ordered store operation or a strong ordered store operation is visible in memory. When the acknowledgement counter reaches a zero value, then all pending virtual address to physical address translations for pending weak ordered store operations and strong ordered store operations are visible in memory. In some examples, such as when processing PCIe store operations, when the pending (post-translation) acknowledgement counter value is zero, and/or the like, MMU 320 can skip pushing the strong ordered store operation to the post-translation buffer. If a pending aperture switch I/O flush operation is pending, then the memory management unit waits for a read operation response to the dummy read operation indicating that data associated with the posted operations is visible in memory,

At step 826, the memory management unit increments a pending acknowledgement counter. The pending acknowledgement counter maintains a count of the ordered store operations that have issued but have not yet been acknowledged. Accordingly, the memory management unit subsequently decrements the pending acknowledgement counter as those acknowledgements are received.

At step 828, the memory management unit forwards the strong ordered store operation to the network interface. The memory management unit can forward the strong ordered store operation to different destinations depending on the aperture associated by the physical address accessed by the store operation. The method 800 then terminates. Alternatively, the method 800 proceeds to step 802, described above, to process additional store operations.

Returning to step 818, if no prior ordered store operations were transmitted to a PCIe aperture, then the method 800 proceeds to step 826, described above. In such cases, no ordered store operations have been transmitted to any aperture prior to the current strong ordered store operation. The memory management unit increments the pending acknowledgement counter and forwards the current strong ordered store operation.

Returning to step 816, If one or more prior ordered store operations were transmitted to a non-PCIe aperture, then the method 800 proceeds to step 824, described above. In such cases, one or more ordered store operations have been transmitted to a non-PCIe aperture prior to the current strong ordered store operation. The memory management unit holds the current strong ordered operation pending acknowledgement that the data from those prior ordered store operations is visible in memory. The memory management unit increments the pending acknowledgement counter and forwards the current strong ordered store operation.

Returning to step 814, if the current strong ordered store operation is directed to the PCIe aperture, then the method 800 proceeds to step 822. At step 822, the memory management unit can rely on ordering enforced by the aperture, but the memory management unit must first determine whether one or more ordered transactions are pending in a non-PCIe aperture. Therefore, at step 822, the memory management unit determines whether one or more prior ordered store operations were transmitted to a non-PCIe aperture. More generally, the memory management unit determines whether prior ordered store operations were transmitted to an aperture that does not support posted operations. If no prior ordered store operations were transmitted to a non-PCIe aperture, then the method 800 proceeds to step 826, described above. In such cases, the memory management unit increments the pending acknowledgement counter and forwards the current strong ordered store operation.

If, at step 822, one or more prior ordered store operations were transmitted to a non-PCIe aperture, then the method 800 proceeds to step 824, described above. In such cases, the memory management unit holds the current strong ordered operation pending acknowledgement that the data from those prior ordered store operations is visible in memory. The memory management unit increments the pending acknowledgement counter and forwards the current strong ordered store operation.

In sum, various embodiments include techniques for performing ordered store operations from a GPU client in a multiprocessor system. In some examples, the techniques perform ordered store operations from a GPC 208 to launch work to a NIC in a multiprocessor system. A NIC can operate by maintaining a circular work queue, where each entry in the queue is referred to a work queue entry (WQE). The circular work queue can be stored in any memory system, such as system memory, PP memory, and/or the like. Each WQE includes a work descriptor that informs the NIC what work is to be performed on the corresponding message data.

With the disclosed the techniques, threads executing in a computing system have an ordered view of memory. The ordered view of memory is a separate view of memory than the standard program memory view where there is no ordering between writes to different addresses without memory synchronization operations. This ordered view, from the perspective of a programmer, provides a mechanism of performing global memory store operations with embedded, hardware-enforced synchronization. The data for any store operation executed in the ordered view can be made visible to any external observer by a subsequent strong ordered store operation in the same view, without the need to execute an additional memory synchronization operation. With these techniques, the threads executing on an SM maintain ordering of store operations up to the point of issuing the store operations to the MMU 320 and memory system. The MMU 320, in turn, ensures that the store operations remain ordered with respect to the previous ordered store operations executed by the threads, as intended by the programmer. The MMU 320 performs additional synchronization operations, as necessary, to ensure that the ordering is maintained without the aid of software techniques or instructions, such as memory synchronization operations.

The disclosed ordered store operations can be classified into two main types: weak ordered store operations and strong ordered store operations. The weak ordered store operations do not enforce strict ordering among themselves except for the basic same-thread-same-address ordering that the GPU memory model provides. The strong ordered store operations, on the other hand, enforce strict ordering with respect to any other prior ordered store operations (including weak ordered store operations and strong ordered store operations). The strong ordered store operations further ensure that the previous ordered store operations are visible at a system scope. The ordered view includes both the weak ordered store operations and strong ordered store operations. Weak ordered store operations provide better performance, although with weaker ordering assurances. Strong ordered store operations provide stricter ordering assurance with somewhat lower performance.

In some examples, ordered store operations are employed in conjunction with implicit hardware enforced ordering. In that regard, store operations directed to the PCIe bus are posted store operations, where the PCIe bus does not return an acknowledgement when a store operation completes, and the data included in the store operation is visible at the destination. Further, PCIe semantics can enforce a policy such that consecutive store operations to any addresses in the PCIe bus address space remain in order. In particular, the PCIe bus includes an RO bit indicating that a memory operation is subject to relaxed ordering. If the relaxed ordering bit is deactivated (RO=0), then the memory operation is not subject to relaxed ordering, indicating that the memory operation is strongly ordered. In such cases, PCIe ordering enforces that all memory store operations to any addresses that are issued prior to the strongly ordered memory operation are pushed to the PCIe bus. If the relaxed ordering bit is activated (RO=1), then the memory operation is subject to relaxed ordering. In such cases, memory store operations that are issued prior to the memory operation with relaxed ordering may or may not be pushed to the PCIe bus. As used herein, if the SM issues a strong ordered store operation directed to the PCIe bus, then the store operation is transmitted on the PCIe bus as a memory store operation with RO=0. As a result, PCIe ordering enforces that all memory store operations on the PCIe bus prior to the memory store operation with RO=0 are pushed.

At least one technical advantage of the disclosed techniques relative to the prior art is that, with the disclosed techniques using ordered store operations, a thread can eliminate memory synchronization operations and still maintain the desired ordering between the individual store operations relative to any physical global memory aperture, such as a system (e.g., CPU attached) memory aperture, a peer device memory aperture, a local device memory aperture, and/or the like. The memory system maintains the appropriate ordering in an efficient manner, while the MMU only inserts waiting periods for visibility of the ordered store operations as needed. By so doing, a strong ordered store operation can maintain cumulative ordering of prior ordered store operations at system scope with higher performance and less processing overhead than conventional techniques that employ memory synchronization operations. These advantages represent one or more technological improvements over prior art approaches.

Any and all combinations of any of the claim elements recited in any of the claims and/or any elements described in this application, in any fashion, fall within the contemplated scope of the present disclosure and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for performing memory store operations, the method comprising:
receiving a first store operation from a first processor;
determining that the first store operation comprises an ordered store operation of a first type; and
maintaining ordering of the first store operation relative to a second store operation comprising an ordered store operation of a second type,
wherein the first processor continues to execute operations while the first store operation is pending.

2. The computer-implemented method of claim 1, wherein maintaining ordering of the first store operation relative to the second store operation comprises delaying execution of the first store operation pending receiving an acknowledgement that data for a second store operation comprising an ordered store operation of a second type is visible in memory.

3. The computer-implemented method of claim 2, wherein:
the ordered store operation of the first type comprises a first strong ordered store operation; and
the ordered store operation of the second type comprises a second strong ordered store operation.

4. The computer-implemented method of claim 1, wherein:
the ordered store operation of the first type comprises a strong ordered store operation; and
the ordered store operation of the second type comprises a weak ordered store operation.

5. The computer-implemented method of claim 1, further comprising:
receiving acknowledgement that data for the second store operation is visible in memory; and
executing the first store operation.

6. The computer-implemented method of claim 1, wherein:
the ordered store operation of the first type comprises a first weak ordered store operation;
the ordered store operation of the second type comprises a second weak ordered store operation; and
execution of the first store operation is not delayed due to pendency of the second store operation.

7. The computer-implemented method of claim 1, further comprising:
prior to receiving the first store operation, receiving a third store operation from the first processor; and
determining that the third store operation comprises an unordered store operation,
wherein execution of the first store operation is not further delayed due to pendency of the third store operation.

8. The computer-implemented method of claim 1, further comprising:
delaying a first virtual address to physical address translation for the first store operation pending completion of a second virtual address to physical address translation for the second store operation.

9. The computer-implemented method of claim 8, further comprising:
determining that the second virtual address to physical address translation for the second store operation has completed; and
performing the first virtual address to physical address translation for the first store operation.

10. The computer-implemented method of claim 9, wherein performing the first virtual address to physical address translation for the first store operation comprises:
accessing a physical address associated with the first store operation from an entry included in a first translation buffer associated with the first processor.

11. The computer-implemented method of claim 9, wherein performing the first virtual address to physical address translation for the first store operation comprises:
generating a physical address associated with the first store operation based on an entry in a page table, wherein the entry in the page table corresponds to a virtual address associated with the first store operation.

12. The computer-implemented method of claim 8, further comprising:
prior to receiving the first store operation, receiving a third store operation from the first processor; and
determining that the third store operation comprises an unordered store operation,
wherein the first virtual address to physical address translation of the first store operation is not further delayed due to a third virtual address to physical address translation of the third store operation.

13. The computer-implemented method of claim 1, further comprising:
receiving a third store operation from the first processor;
determining that the third store operation comprises an ordered store operation and is directed to a first interface that does not support non-posted store operations; and
executing the third store operation without delaying the third store operation to receive an acknowledgement that data for the first store operation is visible in memory.

14. The computer-implemented method of claim 13, wherein the first store operation is directed to the first interface that does not support non-posted store operations.

15. The computer-implemented method of claim 13, wherein the first interface comprises a peripheral component interconnect express (PCIe) interface.

16. The computer-implemented method of claim 1, wherein the first store operation is directed to a first interface that does not support non-posted store operations, and further comprising:
receiving a third store operation from the first processor;
determining that previously sent ordered store operations are visible in memory; and
executing the third store operation without delaying to receive an acknowledgement that data for the first store operation is visible in memory.

17. The computer-implemented method of claim 1, wherein delaying execution of the first store operation maintains ordering between the first store operation and the second store operation relative to a physical memory aperture.

18. The computer-implemented method of claim 17, wherein the physical memory aperture comprises at least one of a system memory aperture, a peer memory aperture, or a video memory aperture.

19. The computer-implemented method of claim 1, wherein the second store operation is directed to a first interface that does not support non-posted store operations and the first store operation is directed to a second interface that supports non-posted store operations.

20. The computer-implemented method of claim 1, wherein:
the first store operation is directed to a first aperture that supports non-posted store operations; and
the second store operation is directed to a second aperture that does not support non-posted store operations; and
further comprising:
delaying the first store operation by inserting an aperture switch input/output flush operation on the second aperture, wherein the aperture switch input/output flush operation comprises a dummy read operation;
receiving a read operation response to the dummy read operation indicating that data associated with the second store operation is visible in memory; and
in response to receiving the read operation response, allowing the first store operation to proceed.

21. A system comprising:
a first processor that:
generates a first store operation; and
a memory management unit that:
receives the first store operation from the first processor,
determines that the first store operation comprises an ordered store operation of a first type, and
delays execution of the first store operation pending receiving an acknowledgement that a second store operation comprising an ordered store operation of a second type,
wherein the first processor continues to execute operations while the first store operation is pending.
